(19) United States
(12) Patent Application Publication
(10) Pub. No.: US 2013/0328244 A1
(43) Pub. Date: Dec. 12, 2013

(54) POLYAMIDES AND METHODS OF MAKING AND USING SAME

(71) Applicant: Bret Ja Chisholm, West Fargo, ND (US)

(72) Inventor: Bret Ja Chisholm, West Fargo, ND (US)

(73) Assignee: NDSU RESEARCH FOUNDATION, Fargo, ND (US)

(21) Appl. No.: 13/993,238

(22) PCT Filed: Dec. 13, 2011
(86) PCT No.: PCT/US11/64533

§ 371 Date: Aug. 27, 2013

Related U.S. Application Data
(60) Provisional application No. 61/422,828, filed on Dec. 14, 2010.

(51) Int. Cl. C08G 69/00

(52) U.S. Cl. CPC C08G 69/00
USPC 264/328.1; 528/367

(57) ABSTRACT

Polyamides, and methods of making and using polyamides, that have a difference between melting temperature (Tₘ) and crystallization temperature (T_{c}) of at most 20° C. are disclosed herein. Such polyamides can exhibit exceptionally fast crystallization kinetics making them suitable for use as engineering thermoplastics in melt processing methods such as injection molding. Particularly useful polyamides include 1,9-nonamethylene adipamide-co-1,9-nonamethylene terephthalamide copolymers.

This application claims the benefit of U.S. Provisional Application No. 61/422,828, filed Dec. 14, 2010, which is hereby incorporated by reference in its entirety.

### GOVERNMENT FUNDING

The present invention was made with government support under Department of Energy Grant No. DE-FG36-08GO88160. The Government has certain rights in this invention.

### BACKGROUND

Organic chemicals are typically derived from building blocks that are obtained from natural gas, petroleum, and coal. Approximately 13 percent of the crude oil used in the United States currently goes into the production of nonfuel chemicals. Since fossil resources are limited, there is a need to develop useful chemicals from renewable resources. Renewable resources that have been used to produce chemicals include plant oils, polysaccharides, sugars, and wood. Of these, plant oils are the most important renewable raw materials for the chemical industry. Chemicals derived from plant oils have been used to produce surfactants, components for cosmetics, lubricants, polymers, coatings, and flooring materials. The utility of a plant oil for a given application depends on the composition of the fatty acids contained in the oil. For example, coconut oil and palm kernel oil are particularly suited for the production of surfactants and cosmetics because they possess relatively high fractions of short and medium chain length (mainly 12 and 14 carbon atoms) fatty acids; while soybean, rapeseed, and sunflower oil, which possess longer chain fatty acids (18 carbon atoms), are used as in polymer and lubricant applications.

Engineering thermoplastics (such as Nylon 6,6) are widely used to prepare parts that may require the mechanical strength and physical and chemical stability that may be provided by thermoplastic material. Engineering thermoplastics are commonly fabricated into the desired parts using melt processing methods such as injection molding. Oxidation of unsaturated fatty acids can be used to produce long-chain aliphatic dicarboxylic acids and diamines useful for the production of polyamides. Polyamides produced from plant oil-derived fatty acids have found utility in applications such as adhesives, inks, and coatings.

However, there is a continuing, unmet need for engineering thermoplastics that can be processed faster and/or under milder conditions in melt processing methods such as injection molding, and particularly for such engineering thermoplastics that are produced at least partially from plant oils.

### SUMMARY

A series of poly(1,9-nonamethylene adipamide-co-1,9-nonamethylene terephthalamide) copolymers were produced using melt polymerization and the thermal properties and crystal structure characterized. The results obtained confirmed that the copolymers exhibit isomorphism. As expected, glass transition temperature and the apparent melting temperature increased with increasing terephthalmide content. Using the difference in the apparent melting temperature to the crystallization temperature as a measure of relative crystallization rate, it was observed that crystallization rate decreased as the terephthalamide content of the copolymer was increased from 0 to 50 mole percent but then sharply increased when increased beyond 50 mole percent. Comparing the thermal properties of copolymers possessing an excess of terethalamide units to the commodity polyamide Nylon 6,6, it is believed that these copolymers may have utility as partially renewable engineering thermoplastics.

In one embodiment, the present disclosure provides polyamides having a difference between melting temperature (Tₘ) and crystallization temperature (T_{c}) of at most 20° C., in some embodiments at most 15° C., and in certain embodiments at most 10° C.; wherein the crystallization temperature (TO is taken as the maximum of the crystallization exotherm of a differential scanning calorimetry (DSC) thermogram obtained by cooling the polyamide from 300° C. to 25° C. at 20° C. per minute; and wherein the melting temperature (Tₘ) is taken as the maximum of the melting endotherm of a differential scanning calorimetry (DSC) thermogram obtained by subsequently heating the polyamide from 25° C. to the molten state at 20° C. per minute. It has been found that polyamide copolymers having a small difference between melting temperature and crystallization temperature can exhibit exceptionally fast crystallization kinetics. Engineering thermoplastics having exceptionally fast crystallization kinetics can be advantageous for use in melt processing methods such as injection molding.

In certain embodiments, such semicrystalline copolymers can include repeating units of at least one alkylene terephthalamide unit and at least one alkylene adipamide unit. Exemplary alkylene terephthalamide repeating units can be of the formula:

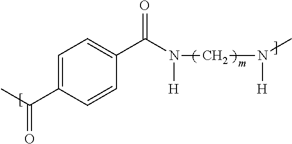

wherein m=6 to 30, and in certain embodiments m=9. Exemplary alkylene adipamide repeating units can be of the formula:

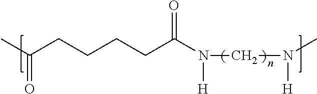

wherein n=6 to 30, and in certain embodiments n=9. In certain embodiments, the copolymer has a molar ratio of alkylene terephthalamide repeating units to alkylene adipamide repeating units of 5:95 to 90:10.

In another aspect, the present disclosure provides methods of fabricating articles from polyamides as disclosed herein. In certain embodiments, an exemplary method can include: providing a polyamide as disclosed herein; and melt processing the polyamide under conditions effective to form the article. Exemplary conditions effective can include one or more of injection molding, compression molding, transfer molding, and extrusion molding.

In another aspect, the present disclosure provides a method of preparing a polyamide copolymer having a difference between melting temperature (Tₘ) and crystallization temperature (T_{c}) of at most 20° C., in some embodiments at most 15° C., and in certain embodiments at most 10° C., wherein crystallization temperature (T_{c}) and melting temperature (Tₘ) are taken as discussed herein above.

In some certain embodiments, the method of preparing a polyamide copolymer can include: providing a copolyamide prepolymer; and heating the copolyamide prepolymer under conditions effective to form a polyamide copolymer having a difference between melting temperature (Tₘ) and crystallization temperature (T_{c}) of at most 20° C., in some embodiments at most 15° C., and in certain embodiments at most 10° C. In some embodiments, the copolyamide prepolymer can include alkylene terephthalamide repeat units (e.g., nonamethylene terephthalamide repeat units) and alkylene adipamide repeat units (e.g., nonamethylene adipamide repeat units). Polyamide copolymers prepared according to this method are also disclosed herein.

In other certain embodiments, the method of preparing a polyamide copolymer can include: combining a first polyamide prepolymer with a second polyamide prepolymer to form a mixture of polyamide prepolymers; and heating the mixture of polyamide prepolymers under conditions effective to form a polyamide copolymer having a difference between melting temperature (Tₘ) and crystallization temperature (T_{c}) of at most 20° C., in some embodiments at most 15° C., and in certain embodiments at most 10° C. In some embodiments, the first polyamide prepolymer includes alkylene terephthalamide repeat units (e.g., nonamethylene terephthalamide repeat units), and the second polyamide prepolymer includes alkylene adipamide repeat units (e.g., nonamethylene adipamide repeat units). Polyamide copolymers prepared according to this method are also disclosed herein.

Optionally, solid state polymerization (SSP) can be used to further increase the molecular weight of the polymer resulting after melt polymerization. Solid state polymerization can be useful, for example, for enhancing the mechanical and rheological properties of polymers before injection molding or extruding. Solid state polymerization is a process in which the polymer chain lengths are increased by heat, typically in the absence of oxygen and water, by means of either vacuum or purging with an inert gas, to drive off the byproducts of reactions (e.g., reactions of active end groups within the solid polymer). The reaction can also be driven by pressure and the diffusion of byproducts from the interior of the polymer to the surface.

Oxidation of a variety of plant oil-derived fatty acids, such as oleic, linoleic, linolenic, eleaosteric, and ricinoleic acids, provide the 9 carbon dicarboxylic acid, azelaic acid, which can be subsequently converted to 1,9-nonane diamine (NDA). Compared to the commodity polyamides, Nylon 6 and Nylon 6,6, which are produced from petrochemical feedstocks, polyamides based on plant oil-derived dicarboxylic acids and diamines possess the positive attribute of lower moisture absorption due to the lower concentration of amide groups. In addition to lower moisture absorption, polyamides based on plant oil-derived dicarboxylic acids and/or diamines possess lower glass transition temperatures and melting points compared to Nylon 6 and Nylon 6,6, which significantly limits their utility for many applications.

### DEFINITIONS

The term “comprises” and variations thereof do not have a limiting meaning where these terms appear in the description and claims.

As used herein, “a,” “an,” “the,” “at least one,” and “one or more” are used interchangeably.

As used herein, the term “or” is generally employed in the sense as including “and/or” unless the context of the usage clearly indicates otherwise.

Also herein, the recitations of numerical ranges by endpoints include all numbers subsumed within that range (e.g., 1 to 5 includes 1, 1.5, 2, 2.75, 3, 3.80, 4, 5, etc.).

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a graphical illustration of glass transition temperature (T_{g}) as a function of copolymer composition for exemplary copolyamides, poly(1,9-nonamethylene adipamide-co-1,9-nonamethylene terephthalamide) (9,6-9,T) having the indicated mole percentages of 9,T repeat units.

FIG. 2 is an illustration of differential scanning calorimetry (DSC) thermograms obtained by cooling exemplary 9,6-9,T copolyamide samples having the indicated mole percentages of 9,T repeat units from the melt at a rate of 20° C./minute.

FIG. 3 is an illustration of DSC thermograms obtained by heating exemplary 9,6-9,T copolyamide samples having the indicated mole percentages of 9,T repeat units from 25° C. to the molten state at a rate of 20° C./minute.

FIG. 4 is a graphical illustration of melting temperature as a function copolymer composition for exemplary 9,6-9,T copolyamide samples having the indicated mole percentages of 9,T repeat units.

FIG. 5 is an illustration of DSC thermograms for an exemplary polyamide, poly(1,9-nonamethylene adipamide) (9,6 which has 0 mole percent 9,T repeat units), produced by cooling from the melt at a rate of 20° C./minute and then heating to the melt at the indicated heating rates.

FIG. 6 is an illustration of DSC thermograms for an exemplary copolyamide 9,6-9,T sample having 30 mole percent 9,T repeat units produced by cooling from the melt at a rate of 20° C./minute and then heating to the melt at the indicated heating rates.

FIG. 7 is an illustration of DSC thermograms for an exemplary copolyamide 9,6-9,T sample having 60 mole percent 9,T repeat units produced by cooling from the melt at a rate of 20° C./minute and then heating to the melt at the indicated heating rates.

FIG. 8 is a graphical illustration of wide angle x-ray diffraction (WARD) patterns for an exemplary 9,6 polyamide (0 mole percent 9,T repeat units), and exemplary 9,6-9,T copolyamide samples having the indicated mole percentages of 9,T repeat units.

FIG. 9 is a graphical illustration of the difference in the peak of the melting endotherm and the peak of the crystallization exotherm (i.e. Tₘ−T_{c} for an exemplary 9,6 polyamide (0 mole percent 9,T repeat units), and exemplary 9,6-9,T copolyamide samples as a function of the mole percentage of 9,T repeat units.

FIG. 10 is a graphical illustration of percentage weight loss in a nitrogen atmosphere as a function of temperature for an exemplary 9,6 polyamide (0 mole percent 9,T repeat units), and exemplary 9,6-9,T copolyamide samples having the indicated mole percentages of 9,T repeat units.

FIG. 11 is a graphical illustration of the temperature associated with weight losses of 5 weight percent and 50 weight percent for an exemplary 9,6 polyamide (0 mole percent 9,T repeat units), and exemplary 9,6-9,T copolyamide samples as a function of the mole percentage of 9,T repeat units

FIG. 12 is a schematic representation of an exemplary process used to produce the polyamide samples used in FIG. 9.

FIG. 13 is a schematic representation of an exemplary process for producing 9,6-9,T polyamide copolymers that involves the separate preparation of 9,6 and 9,T prepolymers.

### DETAILED DESCRIPTION OF ILLUSTRATIVE EMBODIMENTS

For semi-crystalline polymers, copolymerization typically results in a reduction in melting point and crystallization rate due to the inability of the two polymer repeat units to pack into the same crystal lattice. See, for example, Flory, Principles of Polymer Chemistry, 1st Edition, 1953, 568-576; Isasi et al., 2000, Polymer, 41:8813-8823; and Allegra et al., Adv. Polym. Sci., 1969, 6:549. In rare cases, cocrystallization (i.e., isomorphism) of repeat units has been observed. See, for example, Helfand et al., Macromolecules, 1973, 6:631-638; and Natta et al., J. Polym. Sci., 1962, 51:527-539.

Edgar and Hill showed isomorphism for copolyamides based on hexamethylene adipamide and hexamethylene terephthalamide repeat units (Edgar et al., J. Polym. Sci., 1952, 8:1-22). Later, Yu and Evans followed-up on this initial work by determining the effect of diamine structure on the melting point of the copolyamides containing both adipamide and terephthalamide repeat units (Yu et al., J. Polym. Sci., 1960, 42:249-257). Three types of diamines were investigated, namely, straight-chain aliphatic diamines with six to twelve carbon atoms, m-xylylenediamine, and 4,4-dimethyl-1,7-heptanediamine. For each of the straight-chain aliphatic diamines, melting point increased with increasing terephthalamide content which suggested that isomorphism was independent of diamine chain length. By varying the aliphatic chain length and terephthalamide/adipamide ratio, melting point could be tailored from 218° C. to greater than 300° C. For the series of copolyamides based on NDA as the diamine, melting points ranged from 238° C. for the homopolymer, poly(1,9-nonamethylene adipamide), to 295° C. for the copolymer containing an 80/20 molar ratio of terephthalamide repeat units to adipamide repeat units.

Considering the relatively high melting points obtainable with these NDA-based copolyamides, it was of interest to determine the utility of these copolymers for engineering applications such as those currently served by Nylon 6,6. Nylon 6,6, due to its relatively high melting temperature, fast crystallization rate, and good mechanical properties, is a highly utilized engineering plastic that has found application in various metal replacement applications in the automotive and electronics industries. Assuming comparable crystallization kinetics, thermal and mechanical properties, poly(1,9-nonamethylene adipamide-co-1,9-nonamethylene terephthalamide) (poly(9,6-9,T)) copolymers could potentially serve as a partially renewable alternative to Nylon 6,6.

In one embodiment, the present disclosure provides polyamides having a difference between melting temperature (Tₘ) and crystallization temperature (T_{c}) of at most 20° C., in some embodiments at most 15° C., and in certain embodiments at most 10° C.; wherein the crystallization temperature (T_{c}) is taken as the maximum of the crystallization exotherm of a differential scanning calorimetry (DSC) thermogram obtained by cooling the polyamide from 300° C. to 25° C. at 20° C. per minute; and wherein the melting temperature (Tₘ) is taken as the maximum of the melting endotherm of a differential scanning calorimetry (DSC) thermogram obtained by subsequently heating the polyamide from 25° C. to the molten state at 20° C. per minute. In certain embodiments, the polyamide is a copolymer such as a semicrystalline copolymer that can have a γ-form crystal structure. In certain embodiments, the semicrystalline copolymer exhibits isomorphism.

In certain embodiments, such semicrystalline copolymer can include repeating units of at least one alkylene terephthalamide unit and at least one alkylene adipamide unit. Exemplary alkylene terephthalamide repeating units can be of the formula:

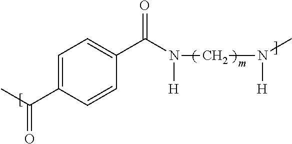

wherein m=6 to 30, and in certain embodiments m=9. Exemplary alkylene adipamide repeating units can be of the formula:

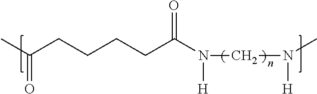

wherein n=6 to 30, and in certain embodiments n=9. In certain embodiments, the copolymer has a molar ratio of alkylene terephthalamide repeating units to alkylene adipamide repeating units of 5:95 to 90:10.

In another aspect, the present disclosure provides methods of fabricating articles from polyamides as disclosed herein. In certain embodiments, an exemplary method can include: providing a polyamide as disclosed herein; and melt processing the polyamide under conditions effective to form the article. Exemplary conditions effective can include one or more of injection molding, compression molding, transfer molding, and extrusion molding.

In another aspect, the present disclosure provides a method of preparing a polyamide copolymer having a difference between melting temperature (Tₘ) and crystallization temperature (T_{c}) of at most 20° C., in some embodiments at most 15° C., and in certain embodiments at most 10° C., wherein crystallization temperature (T_{c}) and melting temperature (Tₘ) are taken as discussed herein above.

In some certain embodiments, the method of preparing a polyamide copolymer can include: providing a copolyamide prepolymer; and heating the copolyamide prepolymer under conditions effective to form a polyamide copolymer having a difference between melting temperature (Tₘ) and crystallization temperature (T_{c}) of at most 20° C., in some embodiments at most 15° C., and in certain embodiments at most 10° C. While not wishing to be bound by theory, it is believed that the selection of sufficiently low melt processing temperatures can lead to the formation of copolymers having longer sequences of 9,T units that may enhance crystal nucleation and lead to increased crystallization rates. In some embodiments, the copolyamide prepolymer can include alkylene terephthalamide repeat units (e.g., nonamethylene terephthalamide repeat units) and alkylene adipamide repeat units (e.g., nonamethylene adipamide repeat units). For such methods, conditions effective can include heating at the prepolymer melting temperature to 90° C. above the prepolymer melting temperature, wherein the prepolymer melting temperature is determined using DSC by heating at 20° C. per minute to the melt. In some embodiments, conditions effective can include heating at the prepolymer melting temperature to 50° C. above the prepolymer melting temperature, and in certain embodiments, at the prepolymer melting temperature to 20° C. above the prepolymer melting temperature. For such methods, conditions effective can include heating for a time of 30 minutes to 5 hours, for some embodiments 30 minutes to 3 hours, and for certain embodiments 30 minutes to 2 hours. Polyamide copolymers prepared according to this method are also disclosed herein.

In other certain embodiments, the method of preparing a polyamide copolymer can include: combining a first polyamide prepolymer with a second polyamide prepolymer to form a mixture of polyamide prepolymers; and heating the mixture of polyamide prepolymers under conditions effective to form a polyamide copolymer having a difference between melting temperature (Tₘ) and crystallization temperature (T_{c}) of at most 20° C., in some embodiments at most 15° C., and in certain embodiments at most 10° C. While not wishing to be bound by theory, it is believed that the use of separate prepolymers along with the selection of appropriate melt processing temperatures can lead to the formation of copolymers having longer sequences of 9,T units that may enhance crystal nucleation and lead to increased crystallization rates. In some embodiments, the first polyamide prepolymer includes alkylene terephthalamide repeat units (e.g., nonamethylene terephthalamide repeat units), and the second polyamide prepolymer includes alkylene adipamide repeat units (e.g., nonamethylene adipamide repeat units). For such methods, conditions effective can include heating at the prepolymer melting temperature to 90° C. above the prepolymer melting temperature, wherein the prepolymer melting temperature is determined using DSC by heating at 20° C. per minute to the melt. In some embodiments, conditions effective can include heating at the prepolymer melting temperature to 50° C. above the prepolymer melting temperature, and in certain embodiments, at the prepolymer melting temperature to 20° C. above the prepolymer melting temperature. For such methods, conditions effective can include heating for a time of 30 minutes to 5 hours, for some embodiments 30 minutes to 3 hours, and for certain embodiments 30 minutes to 2 hours. Polyamide copolymers prepared according to this method are also disclosed herein.

Optionally, solid state polymerization (SSP) can be used to further increase the molecular weight of the polymer resulting after melt polymerization. Solid state polymerization can be useful, for example, for enhancing the mechanical and rheological properties of polymers before injection molding or extruding. Solid state polymerization is a process in which the polymer chain lengths are increased by heat, typically in the absence of oxygen and water, by means of either vacuum or purging with an inert gas, to drive off the byproducts of reactions (e.g., reactions of active end groups within the solid polymer). The reaction can also be driven by pressure and the diffusion of byproducts from the interior of the polymer to the surface.

For certain applications, a polyamide copolymer as disclosed herein can be blended with another polymer (e.g., the same or different than the polyamide copolymers disclosed herein) to provide the desired physical and/or chemical properties. For example, two polyamide copolymers having different molecular weights can be blended to optimize desired physical properties. For another example, two polyamide copolymers having different repeat units can be blended to provide desired physical and/or chemical properties. For even another example, a polyamide copolymer can be blended with another polymer that is not a polyamide copolymer to provide desired physical and/or chemical properties.

Polyamide copolymers as disclosed herein can be used in combination with other materials to form a composite (e.g., a polymer having an additive therein). In addition to one or more polyamide copolymers, composites can include a wide variety of additives, and particularly particulate additives, such as, for example, fillers (e.g., including extending or reinforcing filler particles, fibers, and/or platelet materials), other polymers (e.g., polymer particulate materials such as polytetrafluoroethylene), and combinations thereof. Additives can be dissolved, suspended, and/or dispersed within the composite. For particulate additives, the additive is typically dispersed within the composite.

Additives that can be combined with a polyamide copolymer as disclosed herein to form a composition include, but are not limited to, wetting agents for improving wettability to hydrophobic surfaces, viscosity and flow control agents to adjust the viscosity and thixotropy of the mixture to a desired level, antioxidants to improve oxidative stability of the coatings, dyes or pigments to impart color or radiopacity, and air release agents or defoamers, cure catalysts, cure accelerants, plasticizers, solvents, stabilizers (cure inhibitors, pot-life extenders), and adhesion promoters.

The present invention is illustrated by the following examples. It is to be understood that the particular examples, materials, amounts, and procedures are to be interpreted broadly in accordance with the scope and spirit of the invention as set forth herein.

### EXAMPLES

### Materials.

All materials listed in Table 1 were used as received.

TABLE 1
Starting materials used to produce the Examples.

| Chemical | Source |
|---|---|
| 1,9-nonanediamine (NDA) | Alfa Aesar Chemicals |
| Adipic acid (AA) | Fluka |
| Terephthalic acid (TA) | Sigma-Aldrich |
| Isopropanol (IPA) | VWR International |
| Dichloroacetic acid | Sigma-Aldrich |
| 1,6-hexamemylenediamine | Sigma-Aldrich |
| Reagent alcohol | VWR International |
| Diethyl ether | Sigma-Aldrich |
| Nylon 6 | Sigma-Aldrich |

### Monomer Salt Synthesis.

HMDA Adipate.

The 1/1 mole/mole salt of HMDA and AA (i.e. HMDA adipate) was synthesized by adding 50.0 g (0.342 moles) AA, 39.8 g (0.342 moles) HMDA, 440 g reagent alcohol, and 105.1 g deionized water to a single-neck, one-liter, round-bottom flask containing a stirring magnet. The stirred mixture was heated with a 110° C. oil bath until all solids were dissolved. The solution was then slowly cooled to ambient temperature which caused crystallization of HMDA adipate as translucent, colorless crystals. The crystals were collected by vacuum filtration, washed with reagent alcohol, and dried for 16 hours in a 50° C. vacuum oven. The yield of HMDA adipate was 94%, and the melting point determined using differential scanning calorimetry (DSC) was 205.6° C. The results of elemental analysis were % C, 54.52; % H, 9.61; % N 10.74 which was consistent with theoretical expectations (theor. % C, 54.94; % H, 9.99; % N, 10.68).

NDA Adipate.

The 1/1 mole/mole salt of 1,9-nonane diamine (NDA) and adipic acid (AA) was prepared as follows: 23.70 g (0.15 mole) of NDA was dissolve in 75 ml of hot isopropanol (IPA). 21.90 g (0.15 mole) of AA was dissolve in 150 ml of refluxing IPA. The hot NDA solution was slowly added to the refluxing AA solution. A white solid precipitate was formed almost immediately upon the initial addition of the NDA solution. After the complete addition of the NDA solution, refluxing was continued for one hour. The mixture was filtered hot to collect the precipitate and the precipitate washed with hot IPA (3 15 ml) and dried under vacuum. Yield: 43.2 g (95%). ¹H NMR (400 MHz, CD3OD) δ 2.86 (t, 8 Hz, 4H), 2.18-2.14 (m, 4H), 1.64-1.58 (m, 8H), 1.4-1.32 (m, 10H).

NDA Terephthalate.

The 1/1 mole/mole salt of NDA and terephthalic acid (TA) was prepared as follows: 24.9 g (0.15 mole) of TA and 200 ml of IPA were combined in a 1 L round bottom flask and the mixture heated to reflux. 23.7 g (0.15 mol) of NDA was dissolved in 75 ml of hot IPA and the solution slowly added to the refluxing TA/IPA mixture using rapid stirring. Deionized water was slowly added to the refluxing mixture of TA, NDA, and IPA to dissolve all solids (˜100 ml). Once a all solids had dissolved, the solution was allowed to cool to room temperature which resulted in the formation of a white precipitate. The precipitate was filtered and dried under vacuum. Yield: 46.9 g (97%). ¹H NMR (400 MHz, CD3OD) δ 7.74 (s, 4H), 2.78 (t, 8 Hz, 4H), 1.49-1.42 (m, 4H), 1.14-1.03 (m, 10H).

### Polymer Synthesis.

Nylon 6,6.

Nylon 6,6 was synthesized by adding 5.0 g of hexamethylene diamine adipate salt and 5.0 g of deionized water to a 25 mm×200 mm reaction tube with a 24/40 ground glass joint. The mixture was warmed until all solids were dissolved. The tube was then placed in an oil bath under mechanical overhead stirring and connected to a nitrogen/vacuum manifold. An additional positive pressure nitrogen blanket was provided around the stirrer bearing to insure elimination of air intake upon evacuation of the tube. The tube was evacuated and refilled with nitrogen five times and then heated under stirring (70 rpm) to 220° C. maintaining a nitrogen blanket on the reaction. The reaction was held at 220° C. for 2 hours before the water was allowed to be distilled off, forming a white solid prepolymer. The prepolymer was subsequently heated to 275° C. melting the prepolymer into a transparent, colorless, viscous liquid. Vacuum was applied for 2 hours maintaining an oil bath temperature of 275° C. The tube was then removed from the oil bath and allowed to cool to ambient temperature. Breaking the tube allowed the light gray polymer product to be collected.

Poly(1,9-Nonamethylene Adipamide) and Poly(9,6-9,T) Copolymers.

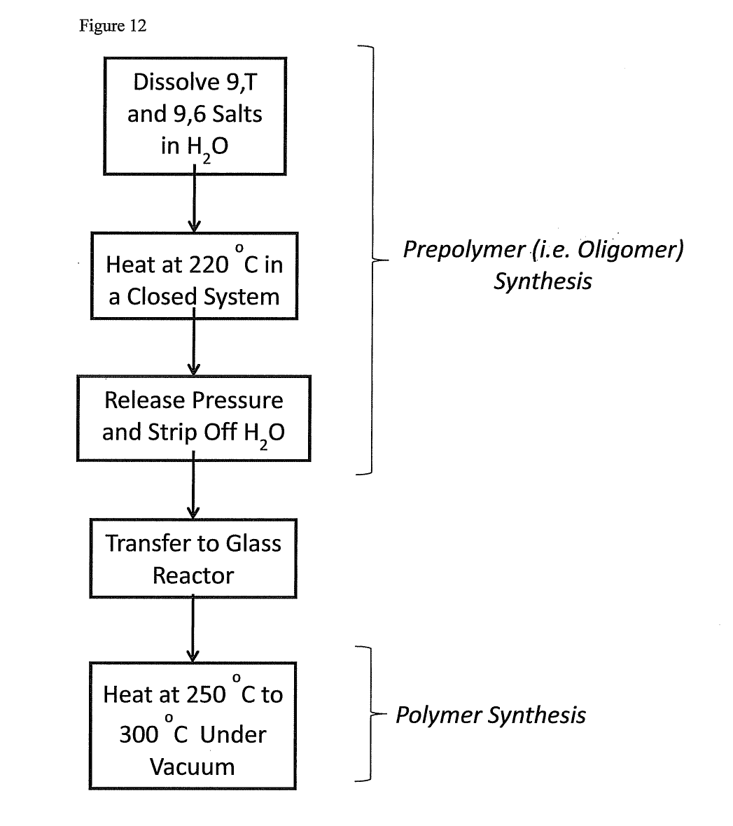

For the Examples described in Table 2, the polymerization process illustrated schematically in FIG. 12 was utilized. First, a 50 wt. % aqueous solution of monomer salts, i.e. NDA/AA and NDA/TA, was prepared in deionized water to produce a total solution weight of approximately 10 grams. Next, the solution was transferred to a 25 mm×200 mm reaction tube with a 24/40 ground glass joint. The tube was then equipped with an overhead stirrer and nitrogen/vacuum manifold and placed in an oil bath. The tube was evacuated and refilled with nitrogen five times and then heated under stirring (70 rpm) to 220° C. maintaining a nitrogen blanket on the reaction. The reaction was held at 220° C. for 2 hours before the water was allowed to be distilled off to produce a white waxy solid (i.e. prepolymer). The prepolymer was subsequently heated to either 275° C. or 290° C. and vacuum applied for 2 hours. For Examples 1-4 and Reference 1, the temperature used for melt polymerization was 275° C. For Examples 5-7, the temperature used for melt polymerization was 290° C. The tube was then removed from the oil bath and allowed to cool to ambient temperature. Breaking the tube allowed the polymer product to be collected.

Solution viscosity measurements were made at 25±0.1° C. using an Ubbelohde viscometer (model 1B from Technical Glass Products, Inc.). 0.10 weight percent polymer solutions were prepared in dichloroacetic acid and intrinsic viscosity [η] calculated using the following equation:

[η]=Sqrt[2(ηₛₚ−ln ηᵣₑₗ)]/c

where ηₛₚ and ηᵣₑₗ are the specific viscosity and relative viscosity, respectively, and c is the concentration of the polymer solution in units of g/ml.

### Characterization.

Before characterization using thermal techniques, all polymer samples were dried in a vacuum oven at 100° C. overnight.

Fundamental thermal properties such as glass transition temperature (T_{g}), melting temperature (Tₘ), and crystallization temperature (T_{c}) of the copolymers were characterized using DSC. The instrument utilized was a TA Q1000 DSC. The experiments were conducted under a N₂ atmosphere, and the instrument was calibrated with an indium standard. Sample sizes ranged from 4.5-7.5 mg, and samples were dried over night in a vacuum oven at 100° C. before conducting measurements. For the measurement of glass transition temperature (T_{g}), samples were first heated from room temperature to 300° C. at a rate of 20° C./minute, then cooled to 25° C. at a rate of 200° C./minute, and finally reheated at 20° C./minute. T_{g} was determined from the final heating ramp. For the measurement of crystallization temperature (T_{c}) and melting temperature (Tₘ), DSC thermograms were obtained by cooling polymer samples from 300° C. to 25° C. at a rate of 20° C./minute and subsequently heating the samples from 25° C. to the molten state at a rate of 20° C./minute. The crystallization temperature (T_{c}) was taken as the maximum of the crystallization exotherm upon cooling from the melt while the melting temperature (Tₘ) taken as the maximum of the melting endotherm upon heating.

Thermal stability was characterized using a Q500 Thermogravimetric Analyzer from TA Instruments. Samples (8.5-10 mg) were heated from 25° C. to 1000° C. at a heating rate of 10° C./min under a nitrogen atmosphere. Temperatures corresponding to 5 and 50 percent weight loss were reported.

Moisture absorption samples of 1-3 g were melt extruded using a Tinius Olsen MP600 Extrusion Plastometer and compressed into small plaques prior to analysis. The analysis was done using an Arizona Instruments Computrac 4000XL Moisture Analyzer. Samples were soaked in distilled water for one week and adsorbed moisture removed by towel drying the specimens prior to analysis. Samples were heated to 210° C., while maintaining this temperature, mass loss was recorded. Once the mass loss slowed to 0.015% moisture/minute, the analysis was complete and the total mass loss measured was recorded as the total moisture absorbed.

X-Ray Diffraction (XRD) data was collected in Bragg-Brentano geometry using a Rigaku Ultima IV instrument (Cu Kα radiation, voltage 40 kV, current 44 mA). The samples were scanned from 2-60 degrees 2-Theta with a step size of 0.025 degrees and a scan time of 10 sec/step. The samples were rotated at 25 rpm. Slits used were a ⅔ mm divergence slit, 10 mm height limiting slit, 5 degree soler slits, ⅔ mm scattering slit, and 0.3 mm receiving slit.

### Results and Discussion.

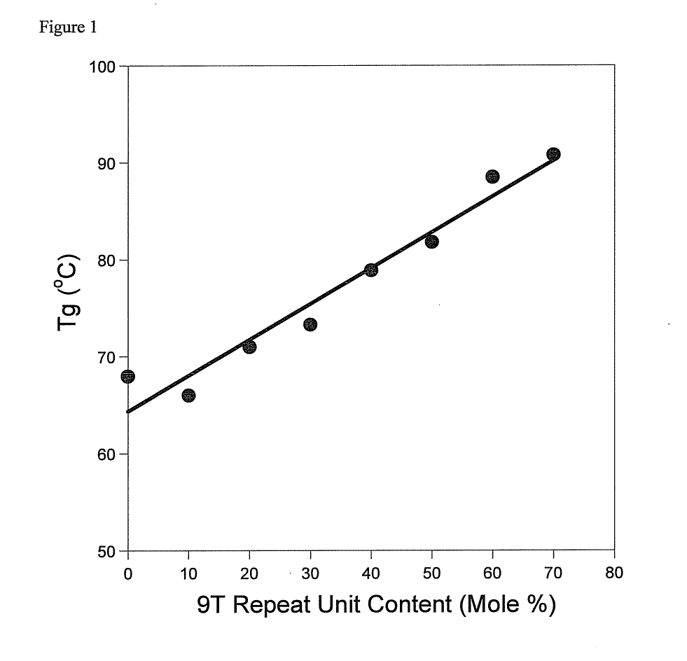

As shown in FIG. 1, T_{g} was found to increase linearly with 9,T content. The increase in T_{g} with 9,T content was approximately 0.37° C./mole percent 9,T in the copolymer. Since the aromatic ring present in the 9,T repeat unit imparts rigidity to the polymer backbone, an increase in T_{g} with increasing 9,T was consistent with expectations and indicated successful copolymerization.

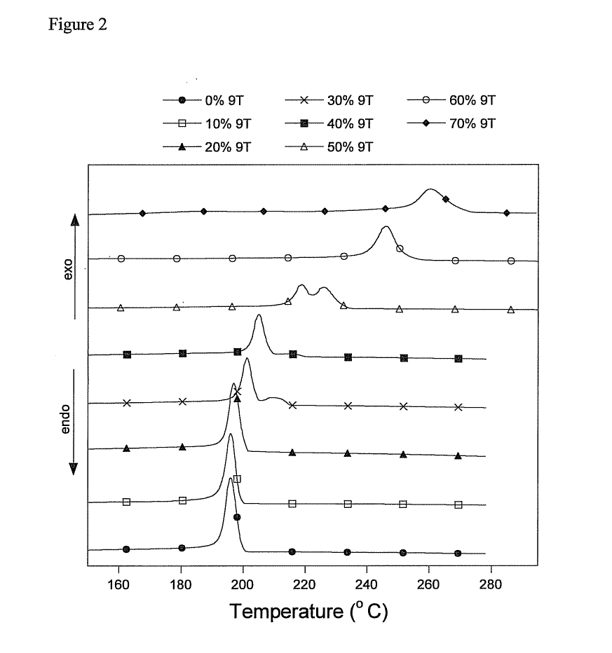

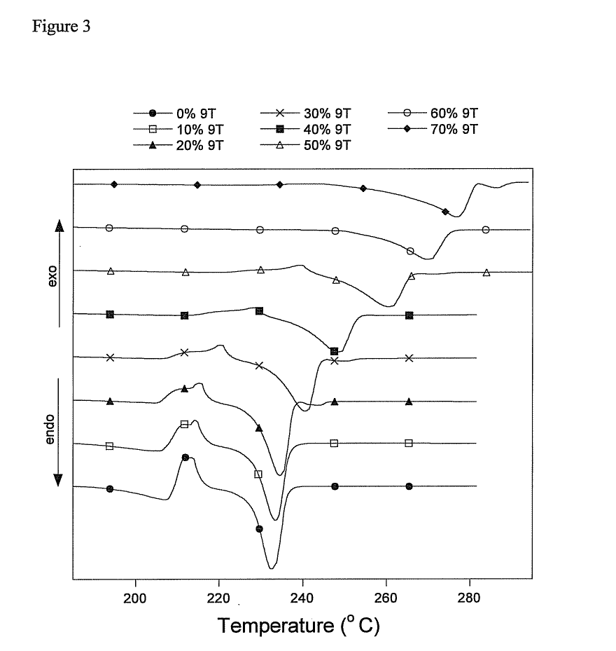

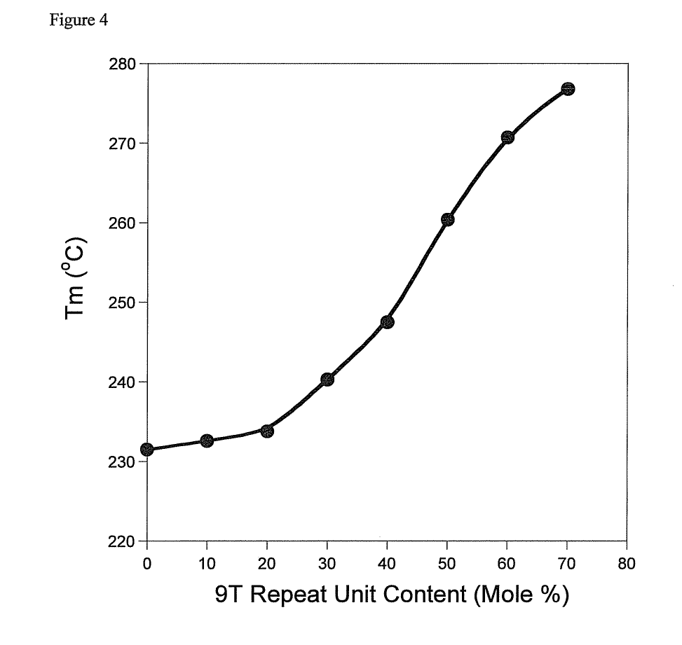

FIGS. 2 and 3 illustrate crystallization and melting behavior of the copolymers, respectively. FIG. 2 displays DSC thermograms obtained by cooling polymer samples from the melt at a rate of 20° C./minute, while FIG. 3 displays thermograms obtained by subsequently heating the samples from 25° C. to the molten state at a rate of 20° C./minute. With regard to melting behavior (FIG. 3), the peak of the melting endotherms increased with increasing 9,T content, as shown in FIG. 4. The sigmoidal relationship between melting temperature and copolymer composition, shown in FIG. 4, is consistent with that observed by Yu and Evans (Yu et al., J. Polym. Sci., 1960, 42:249-257). The absolute values of the melting points we determined using DSC were systematically lower than those reported by Yu and Evans, which is most likely due to the difference in the method used to measure melting point. The maintenance of crystallinity over the entire range of compositions coupled with the lack of a minimum in melting temperature at an intermediate copolymer compositions suggests cocrystallization of the 9,6 and 9,T repeat units. Cocrystallization of 9,6 and 9,T repeat units was previously explained by Edgar and Hill (Edgar et al., J. Polym. Sci., 1952, 8:1-22) as being due to the similar lengths of the adipyl and terephthalyl moieties of the copolymers. The distance between carbonyl groups in terephthalyl and adipyl moieties was calculated to be 5.80 Å and 5.49 Å, respectively. The small difference in repeat unit length between the 9,6 and 9,T units obviously enables cocrystallization.

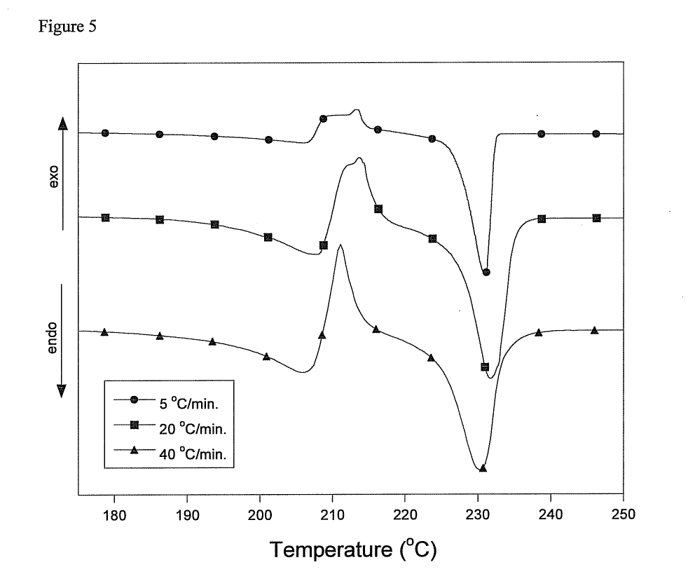

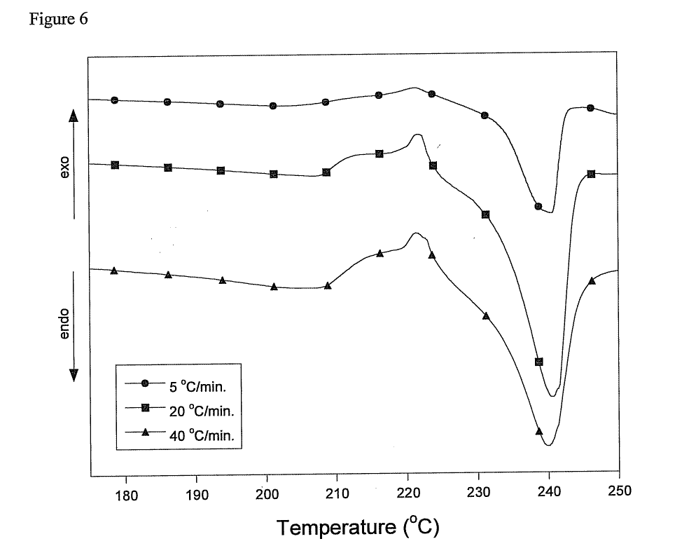

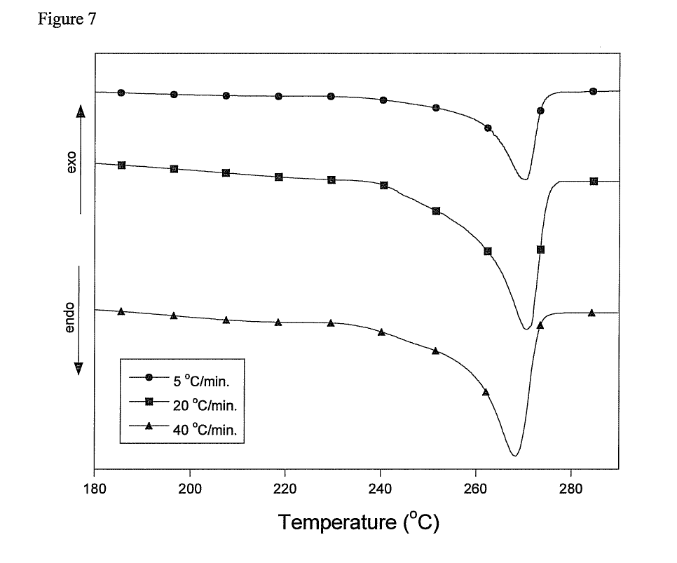

The melting endotherms shown in FIG. 3 suggest that 9,T repeat units not only increase melting temperature but they also increase the stability of crystallites. The melting endotherm for poly(1,9-nonamethylene adipamide) (i.e. 0% 9,T) starts at approximately 185° C. and then at 208° C. the onset of an exotherm is observed indicating relatively rapid crystallization of the low melting crystallities. The newly formed crystallites contribute to the endotherm that starts at approximately 220° C. Crystallite reorganization during the time frame of a nonisothermal DSC experiment has been observed for several aliphatic polyamides such as Nylon 12,12 (Song et al., Chin. J. Polym. Sci., 2006, 24:187493), Nylon 12,14 (Li et al., J. Appl. Polym. Sci., 2003, 88:1581-1589), Nylon 6,6 (Magill et al., Polymer, 1981, 22:43-55), and Nylon 12,10 (Franco et al., J. Polym. Sci. Part B: Polym. Phys., 1995, 33:2065-2073). Since the melting and recrystallization phenomenon observed in a DSC experiment is time dependent, it can be readily confirmed by comparing melting endotherms produced using different heating rates. FIGS. 5, 6, and 7 show DSC thermograms for samples 0% 9,T, 30% 9,T, and 60% 9,T, respectively, that were crystallized by cooling from the melt at a rate of 20° C./minute and then heating to the melt at different heating rates. For 0% 9,T (FIG. 5), the relative area of the exotherm just prior to the main melting endotherm increases with increasing heating rate, which is consistent with a melting-recrystallization process. Increasing the heating rate effectively decreases the amount of time allowed for melting and recrystallization of the thinner, lower melting crystallites into the thicker more stable crystallites represented by the melting endotherm with a peak temperature just above 230° C. As shown in FIG. 3 as well as FIGS. 6 and 7, introduction of 9,T units into the polymer chain reduces the extent of crystallization observed during the heating ramp indicating that the 9,T units produce more stable crystallites that slow or inhibit the melting-recrystallization process. Considering the relative rigidity of the 9,T units as compared to the 9,6 units, it would be expected that increasing the 9,T content would inhibit the melting-recrystallization process.

Crystal morphology was characterized using WAXD. Based on the classification of Kinoshita (Kinoshita, Makromol. Chem., 1959, 33:1-20), aliphatic polyamides typically possess three basic crystal structures. The first crystal structure, referred to as the α-form, has a triclinic unit cell. This crystal structure has been shown for even-even, odd, and most of the even nylons. See, for example, Jones et al., Macromolecules, 2000, 33:2642-2650; Li et al., Cryst. Growth Des., 2003, 3:531-534; and Zhang et al., Cryst. Growth Des., 2004, 2:383-387. The β-form has a monoclinic unit cell and has been observed for the 2N,2(N+1) family of nylons where N is an integer of ≧1. See, for example, Bermudez et al., Macromol. Chem. Phys., 2003, 204:83-88; and Jones et al., Macromolecules, 1997, 30:3569-3578. The third crystal structure is the γ-form and has a near-hexagonal unit cell. According to Kinoshita, the γ-form is the crystal structure characteristic of the even polyamides with a high aliphatic content as well as odd nylons. See, for example, Kinoshita, Makromol. Chem., 1959, 33:1-20; and Kinoshita, Makromol. Chem., 1959, 33:21-31.

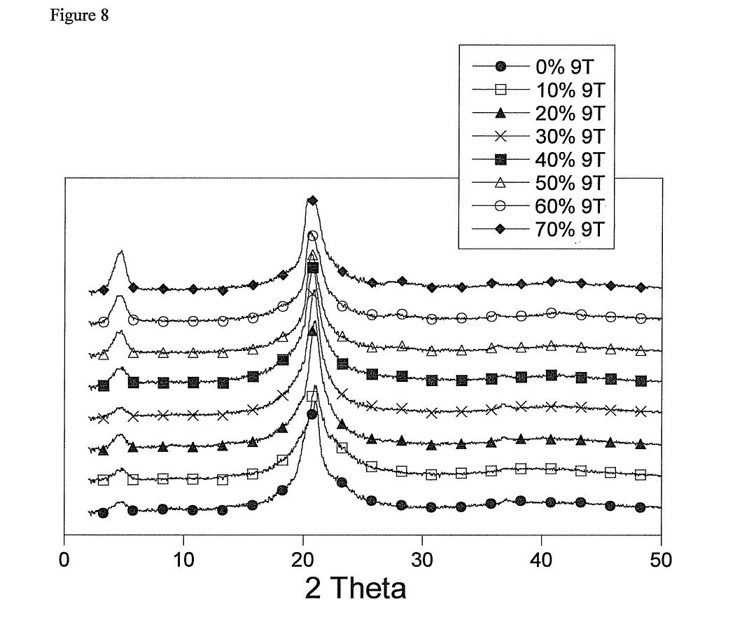

FIG. 8 displays WAXD patterns of the polymers produced. The strong diffraction at 0.42 nm is consistent with the hexagonal unit cell associated with the so-called γ-form crystal structure (Cui et al., Polym. Eng. Sci., 2005, 45:1673-1679). The fact that crystal structure does not change with copolymer composition confirms the original conclusion by Yu and Evans that the copolymers exhibit isomorphism (Yu et al., J. Am. Chem. Soc., 1959, 81:5361-5365).

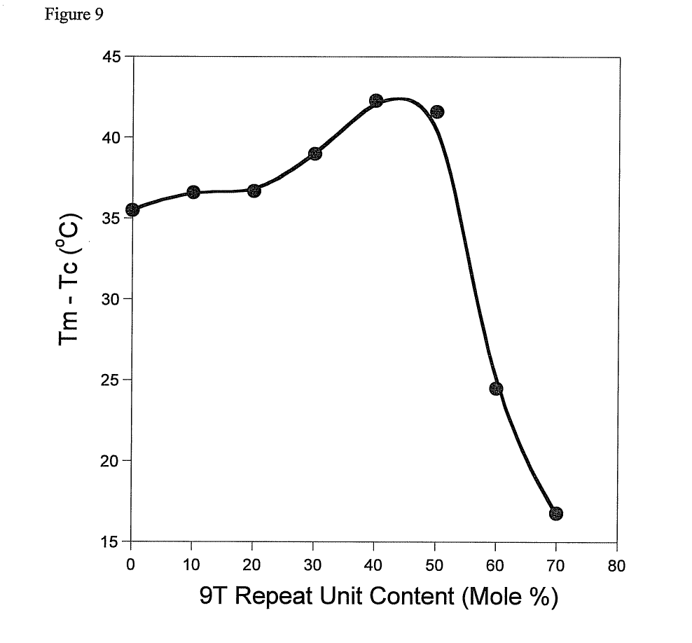

With regard to crystallization, the DSC thermograms shown in FIG. 2 show that crystallization upon cooling from the melt at a constant rate occurs for all copolymer compositions, and crystallization temperature is dependent on copolymer composition. A convenient method for comparing the relative crystallization rates of different polymers is to compare the difference in the apparent melting temperature to the crystallization temperature measured using controlled heating and cooling (Bier et al., Angew. Makromol. Chem., 1977, 65:1-21). The smaller the difference between the apparent melting temperature (Tₘ) and the crystallization temperature (T_{c}), the higher the rate of crystallization. From a practical point-of-view, a smaller Tₘ−T_{c} should enable shorter “cycle times” during injection molding since the minimum time required to eject a newly molded object will depend on the rate of solidification (i.e. crystallization) of the molten polymer upon injection into the mold. FIG. 9 displays the difference in the peak of the melting endotherm and the peak of the crystallization exotherm (i.e. Tₘ−T_{c}) for the different copolymers prepared.

From FIG. 9, it can be seen that Tₘ−T_{c} increased with 9,T contents ranging from 0 to about 50 mole percent. Beyond 50 mole percent 9,T repeat units, Tₘ−T_{c} decreased sharply indicating very fast crystallization for the copolymers containing 60 and 70 mole percent 9,T units.

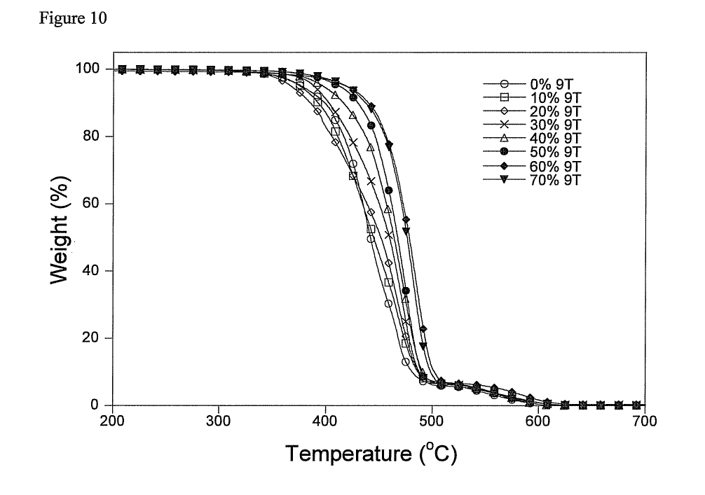

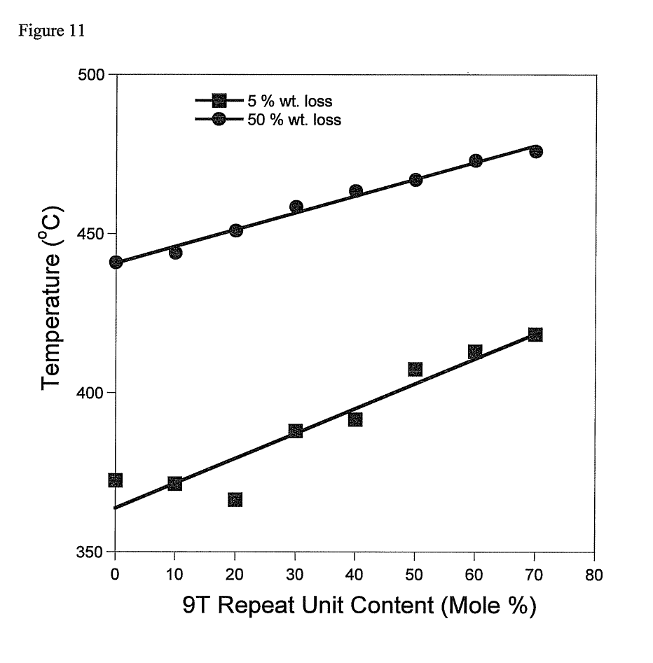

The thermal stability of the copolymers produced was characterized using thermal gravimetric analysis. FIG. 10 displays weight loss as a function of temperature in a nitrogen atmosphere, while FIG. 11 illustrates the variation in temperature associated with a weight loss of 5 and 50 weight percent as a function of copolymer composition. From these two figures, it can be seen that, in general, the thermal stability of the copolymers increased with increasing 9,T content. This trend is consistent with expectations considering the relatively high thermal stability of aromatic rings as compared to aliphatic chains.

Considering the thermal properties measured for the copolymers produced, they are expected to have potential utility as engineering thermoplastics serving applications such as those currently served by the commodity polyamides, Nylon 6 and Nylon 6,6. Nylon 6,6, due its higher T_{g}, Tₘ, faster crystallization rate, and lower moisture uptake has been used to a much greater extent in engineering applications involving injection molding than Nylon 6.

As shown in Table 2, T_{g}, Tₘ, and T_{c} all increased with increasing 9,T content of the copolymers. With regard to crystallization rate as characterized by determining Tₘ−T_{c}, crystallization rate decreased (i.e. Tₘ−T_{c} increased) with increasing 9,T content over 9,T contents ranging from 10 to 40 mole percent. For 9,T contents ranging from 40 to 70 mole percent, crystallization rate sharply increased (i.e. Tₘ−T_{c} decreased). In general, thermal stability increased and water uptake decreased with increasing 9,T content. Overall, 9,6-9,T copolymers possessing 9,T contents above 50 mole percent possess very desirable attributes for use as engineering thermoplastics. For example, high melting points and fast crystallization rates are particularly useful properties for engineering thermoplastics. Fast crystallization is useful because it reduces injection molding cycle time which translates to faster production rates for molded objects.

TABLE 2
Properties of 9,6-9,T copolymers.

| | Ref. 1 | Ex. 1 | Ex. 2 | Ex. 3 | Ex. 4 | Ex. 5 | Ex. 6 | Ex. 7 |
|---|---|---|---|---|---|---|---|---|
| 9,T content | 0 | 10 | 20 | 30 | 40 | 50 | 60 | 70 |
| (mole %) | | | | | | | | |
| Intrinsic vis. | 0.69 | 0.15 | 0.50 | 0.70 | 0.18 | 0.46 | 0.25 | 0.63 |
| (dl/g) | | | | | | | | |
| T_{g} (° C.) | 68 | 66 | 71 | 73 | 79 | 82 | 89 | 91 |
| Tₘ (° C.) | 232 | 233 | 234 | 240 | 248 | 260 | 271 | 277 |
| T_{c} (° C.) | 196 | 196 | 197 | 201 | 205 | 219 | 246 | 260 |
| Tₘ − T_{c} (° C.) | 36 | 37 | 37 | 39 | 43 | 41 | 25 | 17 |
| T @ 5% wt. | 373 | 372 | 367 | 388 | 392 | 408 | 413 | 419 |
| loss (° C.) | | | | | | | | |
| T @ 50% wt. | 441 | 444 | 451 | 459 | 464 | 467 | 473 | 476 |
| loss (° C.) | | | | | | | | |
| Water uptake* | 2.1 | NA | 1.1 | NA | 0.9 | NA | 0.6 | NA |
| (wt. %) | | | | | | | | |

“Ref.” refers to a Reference sample.
“Ex.” Refers to an example of the invention.
*Water uptake after one week of immersion in water.

Table 3 compares the properties of the commodity nylons, i.e. Nylon 6 and Nylon 6,6, with the 9,6-9,T copolymers possessing relatively high 9,T contents. As shown in Table 3, the 9,6-9,T copolymers possessing 9,T contents of 60 and 70 mole percent (i.e. Examples 6 and 7) exhibit higher thermal properties, faster crystallization, and dramatically lower water uptake than either Nylon 6 or Nylon 6,6.

TABLE 3
Comparison of the properties of Nylon 6 and Nylon
6,6 to those obtained for 9,6-9,T copolymers possessing
relatively high contents of 9,T repeat units.

| | Nylon 6 | Nylon 6,6 | Ex. 5 | Ex. 6 | Ex. 7 |
|---|---|---|---|---|---|
| 9,T content (mole %) | — | — | 50 | 60 | 70 |
| T_{g} (° C.) | 50 | 59 | 82 | 89 | 91 |
| Tₘ (° C.) | 219 | 261 | 260 | 271 | 211 |
| T_{c} (° C.) | 173 | 229 | 219 | 246 | 260 |
| Tₘ − T_{c} (° C.) | 46 | 32 | 41 | 25 | 17 |
| T @ 5% wt. loss (° C.) | 391 | 411 | 408 | 413 | 419 |
| T @ 50% wt. loss (° C.) | 447 | 471 | 467 | 473 | 476 |
| Water uptake* (wt. %) | 7.7 | 4.7 | NA | 0.6 | NA |

“Ref.” refers to a reference sample.
“Ex.” Refers to an example of the invention.
*Water uptake after one week of immersion in water.

During the course of experimentation with the 9,6-9,T copolymers some variation in thermal properties were observed. To understand the source of variation, a study was conducted in which the repeatability and reproducibility of the synthesis process was investigated. First, three different 9,6-9,T prepolymers were prepared that contained a 9,T content of 40 mole percent. The same batch of 9,6 monomer salt and 9,T monomer salt was used for all three prepolymers. The process for making the prepolymers was identical for each prepolymer batch (i.e. 220° C. and 2 hour reaction time). A stainless steel closed vessel was used to produce the prepolymers. Table 4 shows the thermal properties measured for the prepolymers using DSC (Examples 8, 9, and 10). The thermal properties for Examples 8, 9, and 10 shown in Table 4 indicate significant batch-to-batch variability associated with prepolymer synthesis. The other Examples described in Table 4 pertain to 9,6-9,T copolymers produced using these three prepolymers. Each prepolymer was used to produce three copolymers to determine the batch-to-batch variability associated with the melt polymerization process. The melt polymerization temperature and melt polymerization time used to produce all copolymers was 275° C. and 1.5 hours, respectively. Melt polymerization was done under stirring and vacuum using as glass vessel. As shown in Table 4, thermal properties of replicate copolymers produced from the same batch of prepolymer was very consistent. Thus, variations of thermal properties for copolymers of the same 9,T content appear to be a result of variation within the prepolymer production.

TABLE 4
Thermal properties of prepolymers and copolymers produced from
the prepolymers. Thermal properties were determined using DSC.

| | | | | Tₘ − |
|---|---|---|---|---|
| | | Tₘ | T_{c} | T_{c} |
| | Description | (° C.) | (° C.) | (° C.) |
| Example 8 | 9,6-9,T prepolymer containing 40% | 229 | 206 | 23 |
| | 9,T | | | |
| Example 9 | 9,6-9,T prepolymer containing 40% | 240 | 214 | 26 |
| | 9,T | | | |
| Example 10 | 9,6-9,T prepolymer containing 40% | 235 | 213 | 22 |
| | 9,T | | | |
| Example 11 | 9,6-9,T copolymer derived from Ex. | 234 | 208 | 26 |
| | 8 | | | |
| Example 12 | 9,6-9,T copolymer derived from Ex. | 235 | 208 | 27 |
| | 8 | | | |
| Example 13 | 9,6-9,T copolymer derived from Ex. | 234 | 208 | 26 |
| | 8 | | | |
| Example 14 | 9,6-9,T copolymer derived from Ex. | 244 | 220 | 24 |
| | 9 | | | |
| Example 15 | 9,6-9,T copolymer derived from Ex. | 245 | 219 | 26 |
| | 9 | | | |
| Example 16 | 9,6-9,T copolymer derived from Ex. | 245 | 218 | 27 |
| | 9 | | | |
| Example 17 | 9,6-9,T copolymer derived from Ex. | 244 | 218 | 26 |
| | 10 | | | |

Table 5 provides data for additional Examples in which the same prepolymer was used to produce three different copolymer replicates. Whereas the Examples described in Table 4 possessed a 9,T content of 40 mole percent, the Examples described in Table 5 possessed a 9,T content of 20 or 60 mole percent. Examples 18, 19, and 20 were produced from the same prepolymer containing 20 mole percent 9,T units, while Examples 21, 22, and 23 were produced from the same prepolymer containing 60 mole percent 9,T units. Similar to the results obtained with the copolymers possessing a 9,T content of 40 mole percent (Table 4), the melt polymerization process appears to be reproducible.

TABLE 5
Thermal property data for Examples produced using the same prepolymer
to generate three different copolymer replicates.

| | 9,T | | | | |
|---|---|---|---|---|---|
| | Content | Melt Polym. | Tₘ | T_{c} | Tₘ − T_{c} |
| | (mole %) | Temp. (° C.) | (° C.) | (° C.) | (° C.) |
| Example 18 | 20 | 260 | 234 | 206 | 28 |
| Example 19 | 20 | 260 | 233 | 207 | 26 |
| Example 20 | 20 | 260 | 232 | 210 | 22 |
| Example 21 | 60 | 295 | 266 | 246 | 20 |
| Example 22 | 60 | 295 | 267 | 245 | 22 |
| Example 23 | 60 | 295 | 266 | 248 | 18 |

To further understand the influence of process variables on copolymer thermal properties, a study was conducted in which the temperature of melt polymerization was varied while all other process parameters were kept constant. Table 6 lists Tₘ, T_{c}, and Tₘ−T_{c} data for 9,6-9,T copolymers possessing a 9,T content of 20 mole percent produced using a melt polymerization time of 1.5 hours and varying melt polymerization temperature. The same prepolymer was used for Examples 24, 25, 26, and 28. From the results shown in Table 6, Tₘ varied over a range of 6° C. (228° C. to 234° C.) while T_{c} varied over a much larger range of 17° C. (195° C. to 212° C.). With regard to the relationship between T_{c} and melt polymerization temperature, the data in Table 6 showed a sharp reduction in T_{c} upon increasing the melt polymerization temperature from 280° C. to 300° C.

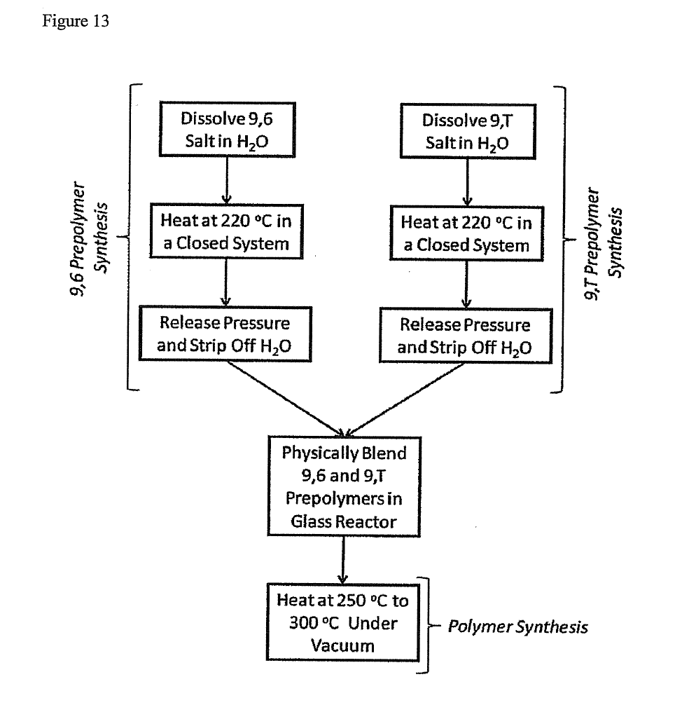

As indicated by FIG. 13, this process involves the separate preparation of 9,6 and 9,T prepolymers. The 9,6 and 9,T prepolymers are then physically blended prior to conducting the melt polymerization process. A representative polymerization using the process described by FIG. 13 is as follows: 20 to 25 g of NDA/AA salt or NDA/TA salt was dissolved in minimum amount of hot water (40 to 50 g for NDA/AA salt and 60 to 75 g for NDA/TA salt) and the solution purged with nitrogen for 20 minutes. The aqueous monomer solution was then transferred to a stainless steel pressure vessel, degassed five times using vacuum, and sealed while being held under vacuum. The reaction mixture was then heated under magnetic stirring to 220° C. The reaction mixture took around one hour to reach 220° C. and the final pressure was around 350 psi. After reaching 220° C., the mixture was held for two hours. After two hours of heating, the pressure was released, the water removed under vacuum, and heating continued for an additional 1.5 hours. The metal reactor was cooled to room temperature and the waxy, brittle prepolymer removed from the reactor. Copolymerization was achieved by physically blending powders of a 9,6 prepolymer and 9,T prepolymer in a glass test tube. The test tube containing 3 to 10 g of the physical mixture of the prepolymer powders was equipped with an overhead stirrer and nitrogen inlet and outlet. The test tube assembly was placed in an oil bath preheated to the polymerization temperature and vacuum placed on the mixture. Once the powders were melted, stirring was started and polymerization allowed to occur over a specified period of time. After completion of the melt polymerization period, the heat was removed, stirring stopped, and reactor allowed to cool to room temperature under vacuum. To collect the polymer, the test tube was sacrificed.

TABLE 6
Thermal properties of 9,6-9,T copolymers possessing
a 9,T content of 20 mole percent.

| | Melt Polym. | | | |
|---|---|---|---|---|
| | Temp. (° C.) | Tₘ (° C.) | T_{c} (° C.) | Tₘ − T_{c} (° C.) |
| Example 24 | 240 | 228 | 209 | 19 |
| Example 25 | 260 | 231 | 210 | 21 |
| Example 26 | 280 | 234 | 212 | 22 |
| Example 27 | 300 | 231 | 195 | 36 |
| Example 28 | 320 | 233 | 197 | 36 |

Table 7 lists Tₘ, T_{c}, and Tₘ−T_{c} data obtained for a study in which five different 9,6-9,T copolymers were produced using both the process described by FIG. 12 (process 1) and the process described by FIG. 13 (process 2). For both processes, the melt polymerization temperature was 300° C. and the melt polymerization time was 1.5 hours. As shown in Table 7, independent of copolymer composition, Tₘ−T_{c} was substantially lower for the copolymer produced using Process 2 as compared to the analogous copolymer produced using Process 1. A lower value for Tₘ−T_{c} indicates faster crystallization which can be very advantageous when molded objects are produced using injection molding.

TABLE 7
Tₘ, T_{c}, and Tₘ − T_{c} data for 9,6-9,T copolymers
produced using a melt polymerization temperature
of 300° C. and polymerization time of 1.5 hours.

| | Melt | 9,T | | | |
|---|---|---|---|---|---|
| | polymerization | content | Tₘ | T_{c} | Tₘ − T_{c} |
| | process | (mole %) | (° C.) | (° C.) | (° C.) |
| Example 8 | Process 1 | 10 | 232 | 196 | 36 |
| Example 9 | Process 2 | 10 | 231 | 222 | 9 |
| Example 10 | Process 1 | 20 | 231 | 195 | 36 |
| Example 11 | Process 2 | 20 | 230 | 223 | 7 |
| Example 12 | Process 1 | 30 | 242 | 205 | 37 |
| Example 13 | Process 2 | 30 | 238 | 229 | 9 |
| Example 14 | Process 1 | 40 | 243 | 217 | 26 |
| Example 15 | Process 2 | 40 | 247 | 237 | 10 |
| Example 16 | Process 1 | 50 | 255 | 238 | 17 |
| Example 17 | Process 2 | 50 | 257 | 243 | 14 |

In conclusion, thermal property characterization and WAXD patterns confirmed the previous conclusion by Yu and Evans (Yu et al., J. Am. Chem. Soc., 1959, 81:5361-5365) that poly(9,6-9,T) copolymers exhibit isomorphism. The melting and crystallization behavior observed as a result of nonisothermal experiments indicated that copolymers possessing an excess of 9,T repeat units crystallize exceptionally fast. Considering the higher T_{g} and Tₘ and faster crystallization of poly(9,6-9,T) copolymers possessing an excess of 9,T units compared to Nylon 6,6, these copolymers may have utility for the generation of new, partially renewable engineering thermoplastics.

The complete disclosure of all patents, patent applications, and publications, and electronically available material (e.g., GenBank amino acid and nucleotide sequence submissions; and protein data bank (pdb) submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A polyamide having a difference between melting temperature (Tₘ) and crystallization temperature (T_{c}) of at most 20° C.;
wherein the crystallization temperature (T_{c}) is taken as the maximum of the crystallization exotherm of a differential scanning calorimetry (DSC) thermogram obtained by cooling the polyamide from 300° C. to 25° C. at 20° C. per minute; and
wherein the melting temperature (Tₘ) is taken as the maximum of the melting endotherm of a differential scanning calorimetry (DSC) thermogram obtained by subsequently heating the polyamide from 25° C. to the molten state at 20° C. per minute.

2. The polyamide of claim 1 wherein the difference between melting temperature (Tₘ) and crystallization temperature (T_{c}) is at most 15° C.

3. The polyamide of claim 2 wherein the difference between melting temperature (Tₘ) and crystallization temperature (T_{c}) is at most 10° C.

4. The polyamide of claim 1 wherein the polyamide is a copolymer.

5. The polyamide of claim 4 wherein the copolymer has a γ-form crystal structure.

6. The polyamide of claim 4 wherein the copolymer exhibits isomorphism.

7. The polyamide of claim 4 wherein the copolymer comprises repeating units of at least one allylene terephthalamide unit and at least one allylene adipamide unit.

8. The polyamide of claim 7 wherein the at least one alkylene terephthalamide unit is of the formula: 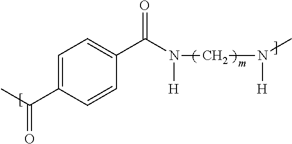
wherein m=6 to 30.

9. The polyamide of claim 8 wherein m=9.

10. The polyamide of claim 7 wherein the at least one alkylene adipamide unit is of the formula: 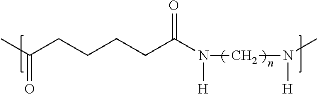
wherein n=6 to 30.

11. The polyamide of claim 10 wherein n=9.

12. The polyamide of claim 7 wherein the copolymer has a molar ratio of alkylene terephthalamide repeating units to alkylene adipamide repeating units of 5:95 to 90:10.

13. A method of fabricating an article comprising:
providing a polyamide according to claim 1; and
melt processing the polyamide under conditions effective to form the article.

14. The method of claim 13 wherein conditions effective comprise one or more of injection molding, compression molding, transfer molding, and extrusion molding.

15. A method of preparing a polyamide copolymer, the method comprising:
providing a copolyamide prepolymer; and
heating the copolyamide prepolymer under conditions effective to form a polyamide copolymer having a difference between melting temperature (Tₘ) and crystallization temperature (T_{c}) of at most 20° C.;
wherein the crystallization temperature (T_{c}) is taken as the maximum of the crystallization exotherm of a differential scanning calorimetry (DSC) thermogram obtained by cooling the polyamide from 300° C. to 25° C. at 20° C. per minute; and
wherein the melting temperature (Tₘ) is taken as the maximum of the melting endotherm of a differential scanning calorimetry (DSC) thermogram obtained by subsequently heating the polyamide from 25° C. to the molten state at 20° C. per minute.

16. The method of claim 15 wherein the difference between melting temperature (Tₘ) and crystallization temperature (T_{c}) is at most 15° C.

17. The method of claim 16 wherein the difference between melting temperature (Tₘ) and crystallization temperature (T_{c}) is at most 10° C.

18. The method of claim 15 wherein the copolyamide prepolymer comprises alkylene terephthalamide repeat units and alkylene adipamide repeat units.

19. The method of claim 18 wherein the alkylene terephthalamide repeat units comprise nonamethylene terephthalamide units, and the alkylene adipamide repeat units comprise nonamethylene adipamide units.

20. The method of claim 19 wherein conditions effective comprise heating at the prepolymer melting temperature to 90° C. above the prepolymer melting temperature for a time of 30 minutes to 5 hours.

21. The method of claim 20 wherein conditions effective comprise heating at the prepolymer melting temperature to 50° C. above the prepolymer melting temperature for a time of 30 minutes to 3 hours.

22. The method of claim 21 wherein conditions effective comprise heating at the prepolymer melting temperature to 20° C. above the prepolymer melting temperature for a time of 30 minutes to 2 hours.

23. A polyamide copolymer prepared by a method according to claim 15.

24. A method of preparing a polyamide copolymer, the method comprising:
combining a first polyamide prepolymer with a second polyamide prepolymer to form a mixture of polyamide prepolymers; and
heating the mixture of polyamide prepolymers under conditions effective to form a polyamide copolymer having a difference between melting temperature (Tₘ) and crystallization temperature (T_{c}) of at most 20° C.;
wherein the crystallization temperature (T_{c}) is taken as the maximum of the crystallization exotherm of a differential scanning calorimetry (DSC) thermogram obtained by cooling the polyamide from 300° C. to 25° C. at 20° C. per minute; and
wherein the melting temperature (Tₘ) is taken as the maximum of the melting endotherm of a differential scanning calorimetry (DSC) thermogram obtained by subsequently heating the polyamide from 25° C. to the molten state at 20° C. per minute.

25. The method of claim 24 wherein the difference between melting temperature (Tₘ) and crystallization temperature (T_{c}) is at most 15° C.

26. The method of claim 25 wherein the difference between melting temperature (Tₘ) and crystallization temperature (T_{c}) is at most 10° C.

27. The method of claim 24 wherein the first polyamide prepolymer comprises alkylene terephthalamide repeat units and the second polyamide prepolymer comprises alkylene adipamide repeat units.

28. The method of claim 27 wherein the alkylene terephthalamide repeat units comprise nonamethylene terephthalamide units, and the alkylene adipamide repeat units comprise nonamethylene adipamide units.

29. The method of claim 24 wherein conditions effective comprise heating at the prepolymer melting temperature to 90° C. above the prepolymer melting temperature for a time of 30 minutes to 5 hours.

30. The method of claim 29 wherein conditions effective comprise heating at the prepolymer melting temperature to 50° C. above the prepolymer melting temperature for a time of 30 minutes to 3 hours.

31. The method of claim 30 wherein conditions effective comprise heating at the prepolymer melting temperature to 20° C. above the prepolymer melting temperature for a time of 30 minutes to 2 hours.

32. A polyamide copolymer prepared by a method according to claim 24.
